(19) United States
(12) Patent Application Publication
(10) Pub. No.: US 2026/0322783 A1
(43) Pub. Date: Oct. 15, 2026

(54) SECURITY ASSOCIATION (SA) QUERY TO OVERCOME DISTRIBUTION SYSTEM (DS) MEDIA ACCESS CONTROL (MAC) ADDRESS COLLISIONS

(71) Applicant: Cisco technology, Inc., San Jose, CA (US)

(72) Inventors: Jerome Henry, Pittsboro, NC (US); Javier Contreras, Barcelona (ES); Domenico Ficara, Essertines-sur-Yverdon (CH); Ugo Mario Campiglio, Morges (CH)

(21) Appl. No.: 19/648,456

(22) Filed: Apr. 15, 2026

Related U.S. Application Data
(60) Provisional application No. 63/789,166, filed on Apr. 15, 2025.

(51) Int. Cl. H04L 61/5046; H04W 8/26; H04W 76/10; H04L 101/622

(52) U.S. Cl. CPC H04L 61/5046; H04W 8/26; H04W 76/10; H04L 2101/622

(57) ABSTRACT

Security Association (SA) query to overcome Distribution System (DS) Media Access Control (MAC) address collisions may be provided. A client device may send to an Access Point (AP), a first association frame comprising a first over-the-air MAC address and a first DS MAC address. Next, the client device may receive from the AP in response to the association frame, an indication that the first DS MAC address is already in use. Then the client device may send to the AP in response to the indication that the first DS MAC address is already in use, an SA query that includes a transaction identifier. The client device may then receive from the AP in response to the SA query, an SA response that includes the transaction identifier. Next the client device may use the SA response to determine a status of an association with the AP.

### RELATED APPLICATION

Under provisions of 35 U.S.C. § 119(e), Applicant claims the benefit of U.S. Provisional Application No. 63/789,166, filed Apr. 15, 2025, which is incorporated herein by reference.

### TECHNICAL FIELD

The present disclosure relates generally to providing Security Association (SA) query to overcome Distribution System (DS) Media Access Control (MAC) address collisions.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing Security Association (SA) query to overcome Distribution System (DS) Media Access Control (MAC) address collisions;

FIG. 2 is a flow chart of a method for providing SA query to overcome DS MAC address collisions; and

FIG. 3 is a block diagram of a computing device.

### DETAILED DESCRIPTION

### Overview

Security Association (SA) query to overcome Distribution System (DS) Media Access Control (MAC) address collisions may be provided. A client device may send to an Access Point (AP), a first association frame comprising a first over-the-air MAC address and a first DS MAC address. Next, the client device may receive from the AP in response to the association frame, an indication that the first DS MAC address is already in use. Then the client device may send to the AP in response to the indication that the first DS MAC address is already in use, an SA query that includes a transaction identifier. The client device may then receive from the AP in response to the SA query, an SA response that includes the transaction identifier. Next the client device may use the SA response to determine a status of an association with the AP.

Both the foregoing overview and the following example embodiments are examples and explanatory only and should not be considered to restrict the disclosure’s scope, as described and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

In the Institute of Electrical and Electronics Engineers (IEEE) 802.11bi standard, an associating client device (e.g., a station) may include an information element referred to as a Distribution System (DS) Media Access Control (MAC) address that may indicate the MAC address that the client device wants an Access Point (AP) to use when representing the client device on the DS. This DS MAC address may be critical because the client device may rotate its over-the-air MAC address and may need a stable MAC address representation to the network’s upper-layer servers like Dynamic Host Configuration Protocol (DHCP) servers, Gateway, etc.

The client device, however, may provide the intended DS MAC address based on some internal algorithm and without any observation of any other MAC address already in use anywhere. A consequence of this may be that this DS MAC address may collide with another client device’s MAC address. In the IEEE 802.11bi standard, there is an isolation between the over-the-air MAC addresses and the DS MAC addresses. As a result, a collision between one client device’s DS MAC address and another client device’s over-the-air MAC address may be tolerated. However, a collision may not be tolerated with another client device’s DS MAC address or any MAC address of any client device that the AP may reach over the layer-2 wired network (including gateways etc.). Accordingly, embodiments of the disclosure may leverage Security Association (SA) to address DS MAC address collision.

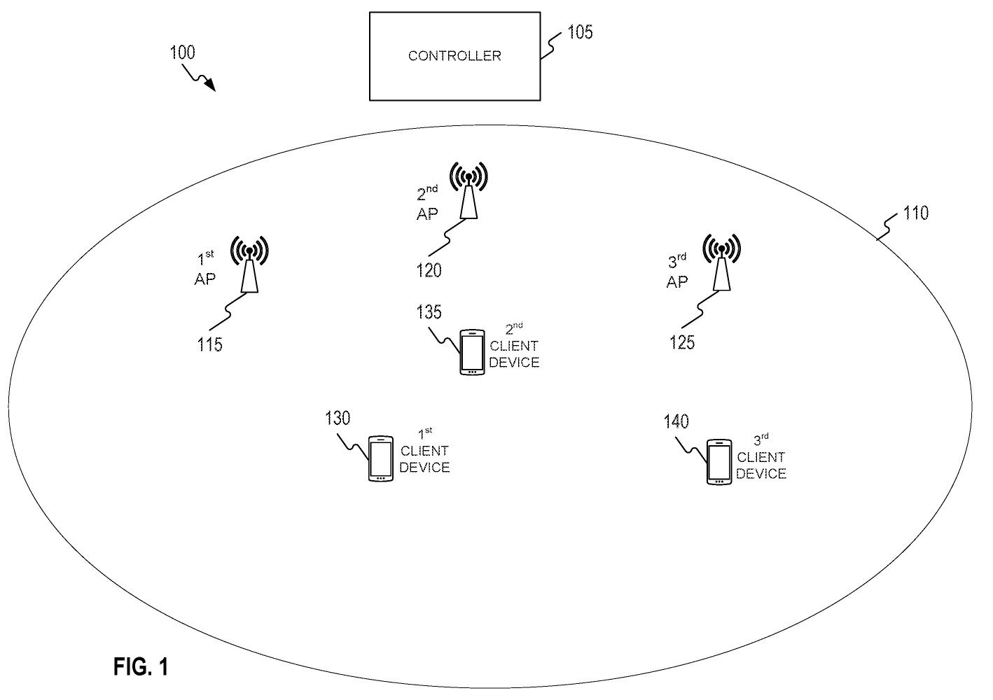

FIG. 1 shows an operating environment 100 for providing Security Association (SA) query to overcome Distribution System (DS) Media Access Control (MAC) address collisions. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs may comprise a first AP 115, a second AP 120, a third AP 125. As described below, the plurality of APs may comprise any number of APs and is not limited to three.

The plurality of APs may provide wireless network access to a plurality of client devices (i.e., Station (STAs)) as they move within coverage environment 110. The plurality of client devices may comprise, but are not limited to, a first client device 130, a second client device 135, and a third client device 140. The plurality of client devices may comprise non-AP Multi-Link Devices (MLDs). Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, an Automated Transfer Vehicle (ATV), a drone, a vehicle, an autonomous vehicle, an Unmanned Aerial Vehicle (UAV), Virtual Reality (VR)/Augmented Reality (AR) devices, or other similar microcomputer-based device. Each of the plurality of APs may be compatible with specification standards such as, but not limited to, the Institute of Electrical and Electronics Engineers (IEEE) 802.11 specification standard.

The plurality of APs and the plurality of client devices may use Multi-Link Operation (MLO) where they simultaneously transmit and receive across different bands (or links) and channels by establishing two or more links to two or more AP radios. Accordingly, the plurality of APs and the plurality of client devices may comprise Multi-Link Devices (MLDs). These bands may comprise, but are not limited to the 2.4 GHz band, the 5 GHz band, the 6 GHz band, and the 60 GHz band. The two or more links on any given one of the plurality of client devices may be made with any one AP or with any combination of the APs.

Controller 105 may comprise a Wireless Local Area Network controller (WLC) and may provision and control coverage environment 110 (e.g., a WLAN). Controller 105 may allow first client device 130, second client device 135, and third client device 140 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide SA query to overcome DS MAC address collisions.

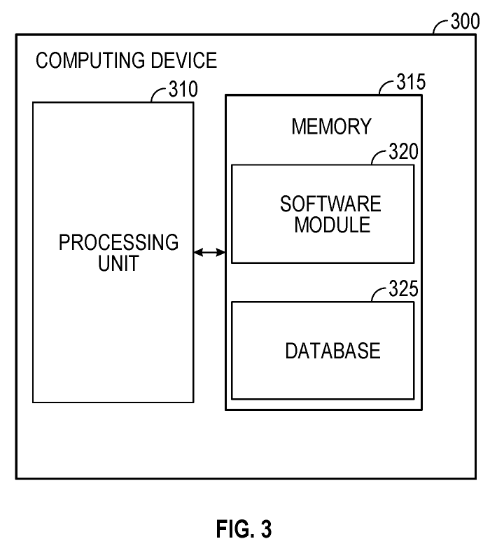

The elements described above of operating environment 100 (e.g., controller 105, first AP 115, second AP 120, third AP 125, first client device 130, second client device 135, or third client device 140) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

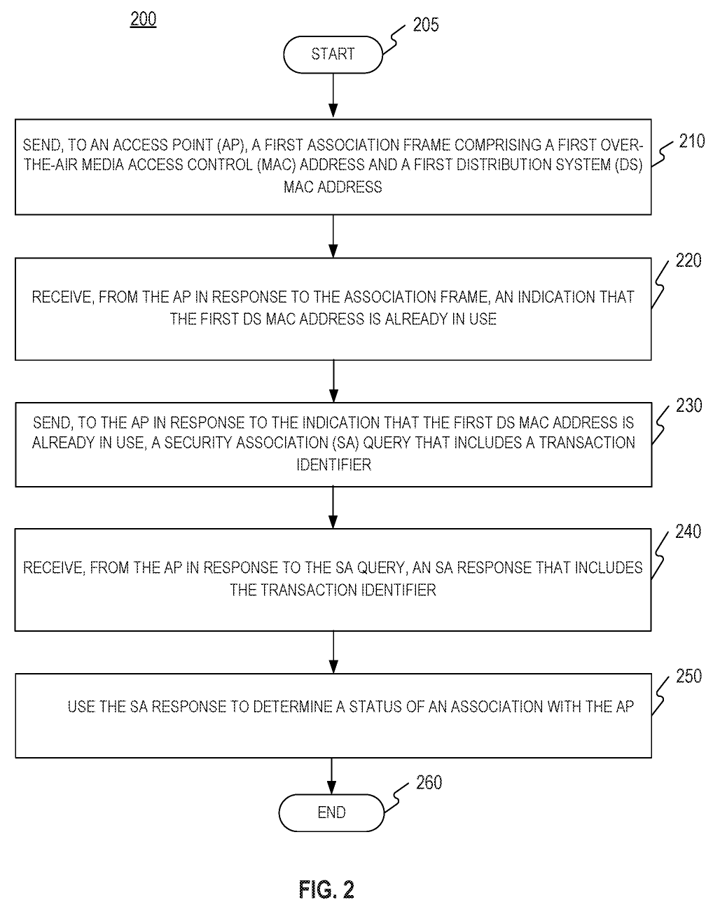

FIG. 2 is a flow chart setting forth the general stages involved in a method 200 consistent with embodiments of the disclosure for providing SA query to overcome DS MAC address collisions. Method 200 may be implemented using first client device 130 that may be embodied by computing device 300 as described in more detail below with respect to FIG. 3. Ways to implement the stages of method 200 will be described in greater detail below.

Method 200 may begin at starting block 205 and proceed to stage 210 where first client device 130 may send, to first AP 115, a first association frame comprising a first over-the-air MAC address and a first DS MAC address. For example, in conventional systems, an SA query may be limited to the validation of an association or authentication frames. Embodiments of the disclosure may extend an SA query use to association frames when the association includes more than a link address, for example, an MLD address in the case of the IEEE 802.11be standard and/or a DS MAC address in the case of the IEEE 802.11bi standard. First client device 130 may send a (re)association frame. The frame includes an additional MAC address (e.g., the DS MAC address).

From stage 210, where first client device 130 sends, to first AP 115, the first association frame comprising the first over-the-air MAC address and the first DS MAC address, method 200 may advance to stage 220 where first client device 130 may receive, from first AP 115 in response to the association frame, an indication that the first DS MAC address is already in use. For example, first AP 115 may examine its Content Addressable Memory (CAM) table and may conclude that the first DS MAC address proposed in the (re)association frame already exists on the DS. Therefore, it initially concludes that first client device 130 should not be represented with that DS MAC address on the DS.

One case may be that the proposed first DS MAC address is not mapped to a client device. In that case, first AP 115 knows that the sending device is a device attempting a (re)association. In other cases, first AP 115 concludes that the proposed first DS MAC address is the DS MAC address of an already associated client device. At that point, first AP 115 does not know if the same client device is attempting a re-association with a new over-the-air MAC address and the same DS MAC address as before (first AP 115 may have missed the disconnection of first client device 130), or if a new client device (e.g., second client device 135) is trying to associate using the DS MAC address already accepted for an already associated client device (e.g., first client device 130).

In one embodiment, where the client device has the initiative of the Source Address (SA) query dialog, the AP responds and the Receiver Address (RA) address is the address of the new over-the-air MAC address that caused the collision (e.g., second client device 135). If the client device is attempting a new association (i.e., it is a different device than first client deceive 130), then the client device (e.g., second client device 135) attempts a new association request with a new DS MAC proposal.

Once first client device 130 receive, from first AP 115 in response to the association frame, the indication that the first DS MAC address is already in use in stage 220, method 200 may continue to stage 230 where first client device 130 may send, to first AP 115 in response to the indication that the first DS MAC address is already in use, a Security Association (SA) query that includes a transaction identifier. For example, if first client device 130 determines that it was associated before, i.e. it is the same device trying to associate and is attempting to re-associate and to reuse a previously provided and valid DS MAC address, then first client device 130 does not know if it’s (previous) association is still valid or not. In other words, first AP 115 has lost track of the over-the-air MAC address of first client device 130 or another client device is attempting to associate with the same DS MAC as first client device 130. In this case, first client device 130 may send an SA query request frame to first AP 115. The frame may operate as an IEEE 802.11w protected management frame, where the frame contains a transaction identifier. First client device 130 may send several of these queries if needed.

After first client device 130 sends, to first AP 115 in response to the indication that the first DS MAC address is already in use, the SA query in stage 230, method 200 may proceed to stage 240 where first client device 130 may receive, from first AP 115 in response to the SA query, an SA response that includes the transaction identifier. For example, first AP 115 may examine the SA query and find the device (e.g., first client device 130) with whom the SA is still valid. In IEEE 802.11bi that client device is identified by its stable MAC, i.e. the DS MAC. If such a client device is found (e.g., first client device 130) and first AP 115 is still in a valid association with the client device, first AP 115 may reply with an SA query response frame, including the same transaction identifier. The response is protected.

From stage 240, where first client device 130 receives, from first AP 115 in response to the SA query, the SA response, method 200 may advance to stage 250 where first client device 130 may use the SA response to determine a status of an association with first AP 115. For example, first client device 130 may attempt to decrypt the received SA response. Upon successfully decrypting the SA response, first client device 130 may know that the association is still valid, and therefore (re)association is not necessary. Then first client device 130 may continue its frame exchanges with first AP 115 without a new (re)association.

Upon failing to decrypt the payload, however, first client device 130 may conclude that the MAC address provided in the DS MAC element indeed collided with another client device’s. First client device 130 may then spin a new DS MAC and attempt a new association request with that new DS MAC information element. Once first client device 130 uses the SA response to determine the status of the association with first AP 115 in stage 250, method 200 may then end at stage 260.

Embodiments of the disclosure may include a scenario where the dialogue is driven by the client device and a scenario where the dialogue is driven by the AP. Above is the scenario where the dialogue is driven by the client device. Below is the scenario where the dialogue is driven by the AP.

In the scenario where the dialogue is driven by the AP, the AP (e.g., first AP 115) receives the association request and does not know if it is a new client device or the same client device as another one for which it already knows the DS MAC. In this embodiment, the AP may have the initiative of the SA dialog. Instead of responding with a reassociation response, the AP responds with an SA query frame addressed to the RA of the client device sending a new association request (e.g., second client device 135). In another embodiment, the AP also responds with an SA query to first client device 130. The SA query request includes a transaction identifier and is encrypted.

The client device (e.g., first client device 130) attempts to decrypt the SA query frame. Upon successfully decrypting the SA query frame, the client device concludes that there is a valid SA association with the AP and responds with an SA query response that includes in the encrypted payload the transaction identifier. The AP records the mapping between the client device’s over-the-air MAC address and its DS MAC and proceeds to continue its dialogue with that client device. However, upon failing to decrypt the SA query frame, the client device concludes that the SA query is the result of a collision perceived on the AP side, and that the AP already has a successful security association with another client device. As a result, the client device attempts a new association frame with a different DS MAC address.

FIG. 3 shows computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for providing SA query to overcome DS MAC address collisions as described above with respect to FIG. 2. Computing device 300, for example, may provide an operating environment for controller 105, first AP 115, second AP 120, third AP 125, first client device 130, second client device 135, or third client device 140. Controller 105, first AP 115, second AP 120, third AP 125, first client device 130, second client device 135, or third client device 140 may operate in other environments and are not limited to computing device 300.

Computing device 300 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 300 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
sending, by a client device to an Access Point (AP), a first association frame comprising a first over-the-air Media Access Control (MAC) address and a first Distribution System (DS) MAC address;
receiving, by the client device from the AP in response to the association frame, an indication that the first DS MAC address is already in use;
sending, by the client device to the AP in response to the indication that the first DS MAC address is already in use, a Security Association (SA) query that includes a transaction identifier;
receiving, by the client device from the AP in response to the SA query, an SA response that includes the transaction identifier; and
using, by the client device, the SA response to determine a status of an association with the AP.

2. The method of claim 1, wherein using, by the client device, the SA response to determine the status of the association with the AP comprises determining that the association with the AP is valid when the client device is able to decrypt the SA response.

3. The method of claim 2, further comprising the client device and the AP continuing frame exchanges in response to determining that the association with the AP is valid.

4. The method of claim 1, wherein using, by the client device, the SA response to determine the status of the association with the AP comprises determining that the association with the AP is invalid when the client device is not able to decrypt the SA response.

5. The method of claim 4, further comprising creating, by the client device, a new association with the AP in response to determining that the association with the AP is invalid.

6. The method of claim 5, further comprising the client device and the AP exchanging frames over the new association.

7. The method of claim 5, wherein creating the new association comprises sending, by the client device to the AP, a second association frame comprising a second over-the-air MAC address and a second DS MAC address.

8. The method of claim 1, wherein receiving the indication that the first DS MAC address is already in use comprises receiving the indication in response to the AP determining that the first DS MAC address is already in use.

9. A system comprising:
a memory storage; and
a processing unit disposed in a client device and coupled to the memory storage, wherein the processing unit is operative to:
send, to an Access Point (AP), a first association frame comprising a first over-the-air Media Access Control (MAC) address and a first Distribution System (DS) MAC address;
receive, from the AP in response to the association frame, an indication that the first DS MAC address is already in use;
send, to the AP in response to the indication that the first DS MAC address is already in use, a Security Association (SA) query that includes a transaction identifier;
receive, from the AP in response to the SA query, an SA response that includes the transaction identifier; and
use the SA response to determine a status of an association with the AP.

10. The system of claim 9, wherein the processing unit being operative to use the SA response to determine the status of the association with the AP comprises the processing unit being operative to determine that the association with the AP is valid when the client device is able to decrypt the SA response.

11. The system of claim 10, further comprising the client device and the AP continuing frame exchanges in response to the processing unit being operative to determine that the association with the AP is valid.

12. The system of claim 9, wherein the processing unit being operative to use the SA response to determine the status of the association with the AP comprises the processing unit being operative to determine that the association with the AP is invalid when the client device is not able to decrypt the SA response.

13. The system of claim 12, wherein the processing unit is further operative to create a new association with the AP in response to determining that the association with the AP is invalid.

14. The system of claim 13, wherein the client device and the AP exchange frames over the new association.

15. The system of claim 13, wherein the processing unit being further operative to create the new association comprises the processing unit being operative to send, to the AP, a second association frame comprising a second over-the-air MAC address and a second DS MAC address.

16. The system of claim 9, wherein the processing unit being operative to receive the indication that the first DS MAC address is already in use comprises the processing unit being operative to receive the indication in response to the AP determining that the first DS MAC address is already in use.

17. A method comprising:
receiving, by an Access Point (AP) from a client device, a first association frame comprising a first over-the-air Media Access Control (MAC) address and a first Distribution System (DS) MAC address;
determining, by the AP in response the association frame, that the first DS MAC address is already in use; and
sending, by the AP to the client device, in response to the first DS MAC address being already in use, a Security Association (SA) query that includes a transaction identifier.

18. The method of claim 17, further comprising receiving, by the AP from the client device in response to the SA query, an SA response that includes the transaction identifier when the client device is able to decrypt the SA response.

19. The method of claim 17, further comprising determining, by the AP, that an association with the client device is invalid when a response to the SA query is not received when the client device is not able to decrypt the SA response.

20. The method of claim 19, further comprising creating, by the AP, a new association with the client device in response to determining that the association with the client device is invalid.
